(19) United States
(12) Patent Application Publication
(10) Pub. No.: US 2024/0147889 A1
(43) Pub. Date: May 9, 2024

(54) WORK VEHICLE GUIDANCE AND/OR AUTOMATION OF TURNS WITH RESPECT TO A RESTRICTED BOUNDARY OF A WORK AREA

(71) Applicant: Deere & Company, Moline, IL (US)

(72) Inventors: SHRIRAAM PRABU SUBRAMANIAN, Pune (IN); MANU PODUVAL, Pune (IN); DIVYA GURNANI, Pune (IN); SOUVIK MAJHI, Pune (IN); Simon W. SCHAEFER, Urbandale, IA (US)

(21) Appl. No.: 17/983,503

(22) Filed: Nov. 9, 2022

(51) Int. Cl. A01B 69/04; G01C 21/34; G05D 1/02

(52) U.S. Cl. CPC A01B 69/008; G01C 21/3461; G05D 1/0214; G05D 2201/0201

(57) ABSTRACT

Systems and methods are provided for guidance and/or automation of work vehicles operating within defined work areas. The system may include a work vehicle controller. At least one boundary is determined with respect to the defined work area as being restricted for traverse by the work vehicle. Upon determining a current vehicle path will traverse a portion of the boundary, a revised vehicle path is automatically generated to avoid traverse of the boundary portion and further at least in part on vehicle motion characteristics such as an available minimum turn radius and/or a wheel angle rate of the work vehicle. Output signals are provided corresponding to the revised vehicle path, which may include for example control signals for automating an advance of the work vehicle along the revised vehicle path, or signals for generating a user interface visually guiding a vehicle operator with respect to the revised vehicle path.

### FIELD OF THE DISCLOSURE

The present disclosure relates generally to a method and system for path planning, as well as operator guidance and/or automation of a work vehicle with respect to a restricted (e.g., impassable or non-traversable) boundary of a work area.

### BACKGROUND

A path planner may be used to determine one or more path plans for a self-propelled work vehicle to cover a work area. The work area may for example represent a field for growing a crop or other vegetation. The work vehicle may need to traverse the entire work area or a portion thereof to plant a crop, to treat a crop, to harvest a crop, or to perform another task associated with the crop or vegetation, to name non-limiting examples.

Conventional guidance systems are known to allow operators to navigate end turns that are defined by guidance line and boundary information. However, the conventional tools lack appropriate mechanisms in the event of restrictions in making the end turns, for example where non-passable boundaries exist with respect to the work area.

It would accordingly be desirable to programmatically distinguish between passable and non-passable boundary data, and further to dynamically select or even establish turn types in such a way that the work vehicle covers the entire work area or required portions thereof but does not traverse restricted portions of a defined boundary.

### BRIEF SUMMARY

The current disclosure provides an enhancement to conventional systems, at least in part by introducing a novel system and method for proactively identifying that a work vehicle will inappropriately traverse a boundary defined as non-passable, for example where traversal of the boundary may result in damage to the work vehicle or associated equipment, and further to programmatically generate alternative turns and/or paths that adhere to the defined boundaries and also properly account for work vehicle characteristics such as vehicle dynamics.

According to a first embodiment as disclosed herein, a computer-implemented method is provided for guidance and/or automation for a self-propelled work vehicle operating within a defined work area. The method includes determining at least one boundary with respect to the defined work area as being restricted for traverse by the work vehicle. Upon determining that a current vehicle path will traverse a portion of the at least one boundary, the method further includes automatically generating a revised vehicle path based on the portion of the at least one boundary and further at least in part on one or more vehicle motion characteristics, and producing one or more output signals corresponding to the revised vehicle path.

In one exemplary aspect according to the above-referenced first embodiment and other embodiments as further disclosed herein, the one or more vehicle motion characteristics may comprise an available minimum turn radius and/or a wheel angle rate determined with respect to the work vehicle.

In a second embodiment, further exemplary aspects according to the above-referenced first embodiment may include determining a further at least one boundary internally disposed with respect to the restricted at least one boundary, wherein the further at least one boundary is unrestricted for traverse by the work vehicle, and wherein the step of determining the current vehicle path will traverse the portion of the restricted at least one boundary is responsive to determining a traverse by the work vehicle of a portion of the further at least one boundary.

In a third embodiment, further exemplary aspects according to either of the above-referenced first and second embodiments may include predicting a traverse of the portion of the at least one boundary based at least in part on a detected position and detected motion of the work vehicle, further accounting for at least one of the one or more vehicle motion characteristics.

In a fourth embodiment, further exemplary aspects according to any of the above-referenced first to third embodiments may include a controlled intervention in at least an advance of the work vehicle with respect to the portion of the at least one boundary, responsive to the produced one or more output signals.

Further exemplary aspects according to the above-referenced fourth embodiment may include automating implementation of the revised vehicle path via automatically controlled operating parameters for the work vehicle.

In a fifth embodiment, further exemplary aspects according to any of the above-referenced first to fourth embodiments may include the one or more output signals being provided to an onboard display unit associated with the work vehicle to generate a display highlighting one or more aspects of the revised vehicle path.

In a sixth embodiment, further exemplary aspects according to any of the above-referenced first to fifth embodiments may include analyzing one or more of a plurality of predetermined vehicle turn types with respect to the portion of the at least one boundary, based at least in part on a detected position and detected motion of the work vehicle, further accounting for at least one of the one or more vehicle motion characteristics, and selectively generating the revised vehicle path as corresponding to at least one of the one or more predetermined vehicle turn types.

Further exemplary aspects according to the above-referenced sixth embodiment may include, upon determining that none of the plurality of predetermined vehicle turn types are available for generating the revised vehicle path, based at least in part on the detected position and the detected motion of the work vehicle, further accounting for the at least one of the one or more vehicle motion characteristics, generating a new turn type with respect to the portion of the at least one boundary.

In another embodiment, a system is disclosed herein for guidance and/or automation of a self-propelled work vehicle operating within a defined work area. The system comprises data storage having stored thereon one or more vehicle motion characteristics, one or more sensors configured to detect a position and/or motion of the work vehicle, and at least one computing device functionally linked to the data storage and configured to direct the performance of operations according to any of the above-referenced first to sixth embodiments.

In another embodiment, a self-propelled work vehicle is disclosed herein which comprises a system according to the above-referenced embodiment, wherein the at least one computing device may for example include a vehicle controller.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a block diagram representing a work vehicle control system according to an embodiment of the present disclosure.

FIG. 2 is a flowchart representing an exemplary method according to an embodiment of the present disclosure.

FIG. 3 is a graphical diagram representing a typical vehicle turn path with respect to a passable exterior boundary.

FIGS. 4A to 4C are graphical diagrams representing an exemplary revised vehicle path to avoid traverse of a non-passable exterior boundary according to the present disclosure.

FIG. 5 is a graphical diagram similar to FIG. 3 showing another example of a typical vehicle turn path with respect to a passable exterior boundary. This example shows a vehicle including a tractor and a towed implement.

FIG. 6 is a graphical diagram similar to FIGS. 4A-4C showing an example of an exemplary revised vehicle path for the vehicle of FIG. 5 to avoid traverse of a non-passable exterior boundary according to the present disclosure.

FIG. 7 schematically illustrates the virtual vehicle boundary for the vehicle of FIGS. 5 and 6.

### DETAILED DESCRIPTION

With reference herein to the representative figures, various embodiments may now be described of an inventive system and method.

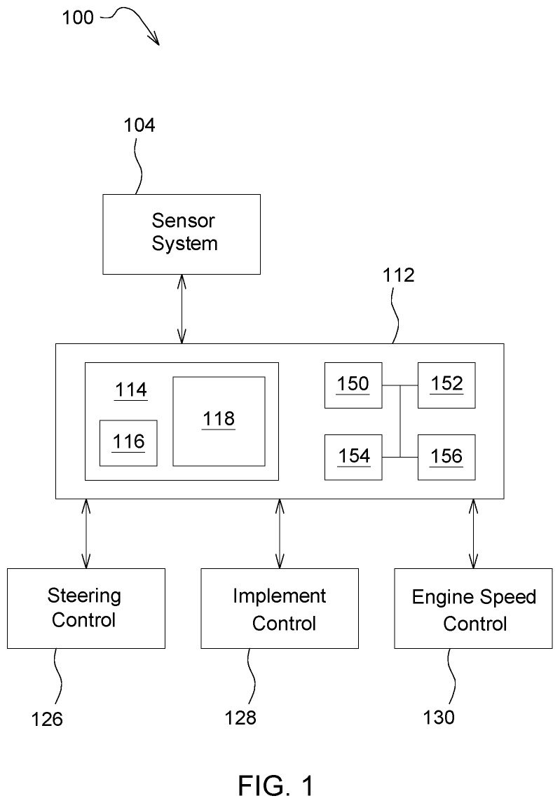

FIG. 1 in a particular embodiment as disclosed herein shows a system 100 for planning, guidance, and/or control of the path of a work vehicle 102 relative to defined boundaries of a work area. The system 100 of FIG. 1 includes a sensor system 104 coupled or otherwise functionally linked to a vehicle controller 112 including a user interface 114. In turn, the vehicle controller 112 may have integrated therein or otherwise communicate with a steering control unit 126, an implement control unit 128, and/or an engine speed control unit 130. Such control units and respective functions, among others, may be discrete in nature or otherwise combined in various embodiments without departing in any way from the scope of the present disclosure.

The vehicle controller 112 may generate output signals corresponding to display and/or automatic control of various operations of the work vehicle 102 consistent with a generated path plan, which may be an initial path plan or a revised path as discussed further herein for example to avoid traverse of a restricted boundary. The vehicle controller 112 may generate control signals for any or all of the steering control unit 126, the implement control unit 128, and/or the engine speed control unit 130, and/or any other component or system that is/are consistent with tracking a vehicle path and subject to modification or interruption by the system 100 or another system. For example, control signals may comprise a steering control signal or data message that defines a steering angle of the steering shaft, a braking control signal or data message that defines the amount of deceleration, hydraulic pressure, or braking friction to the applied to brakes, a propulsion control signal or data message that controls a throttle setting, a fuel flow, a fuel injection system, vehicular speed, or vehicular acceleration. Further, where the vehicle 102 may be propelled by an electric drive or electric motor, the propulsion control signal may control or modulate electrical energy, electrical current, electrical voltage provided to an electric drive or motor. The control signals generally vary with time as necessary to track the path plan. The lines that interconnect the components of the system 100 may comprise logical communication paths, physical communication paths, or both. Logical communication paths may comprise communications or links between software modules, instructions or data, whereas physical communication paths may comprise transmission lines, data buses, or communication channels, to name non-limiting examples.

The steering control unit 126 may comprise or otherwise interact with an electrically controlled hydraulic steering system, an electrically driven rack and pinion steering, an Ackerman steering system, or another steering system. The engine speed control unit 130 may comprise or otherwise interact with an internal combustion engine, an internal combustion engine-electric hybrid system, an electric drive system, or the like.

The sensor system 104 may for example comprise components of a navigation system and/or position determining system which individually or collectively include one or more of global positioning system (GPS) sensors, vehicle speed sensors, ultrasonic sensors, laser scanners, radar wave transmitters and receivers, thermal sensors, imaging devices, structured light sensors, and other optical sensors, wherein exemplary imaging devices may include a digital (CCD/CMOS) camera, an infrared camera, a stereoscopic camera, a time-of-flight/depth sensing camera, high resolution light detection and ranging (LiDAR) scanners, radar detectors, laser scanners, and the like within the scope of the present disclosure. In various embodiments the sensor system 104 may include sensors located on other work vehicle operating in the same work area, input values from such sensors, user inputs from a user interface 114 associated with the work vehicle 102 as further discussed below, and the like.

The vehicle controller 112 may be configured to produce outputs, as further described below, to a user interface 114 associated with a display unit 118 for display to the human operator. The vehicle controller 112 may be configured additionally or in the alternative to produce outputs to a display unit independent of the user interface 114 such as for example a mobile device associated with the operator or a remote display unit independent of the work vehicle 102. The vehicle controller 112 may be configured to receive inputs from the user interface 114, such as user input provided via the user interface 114. Not specifically represented in FIG. 1, the vehicle controller 112 may in some embodiments further receive inputs from remote devices associated with a user via a respective user interface, for example a display unit with touchscreen interface. Data transmission between for example the vehicle controller 112 and a remote user interface may take the form of a wireless communications system and associated components as are conventionally known in the art. In certain embodiments, a remote user interface and vehicle control systems for respective work vehicles may be further coordinated or otherwise interact with a remote server or other computing device for the performance of operations in a system as disclosed herein.

The vehicle controller 112 may for example include or be associated with a processor 150, a computer readable medium 152, a communication unit 154, data storage 156 such as for example may include a database network, and the aforementioned user interface 114 (for example as part of an onboard vehicle control panel or otherwise discretely disposed) having a display 118. An input/output device 116, such as a keyboard, joystick, touch screen, or other user interface tool, may be provided so that the human operator may input instructions to the vehicle controller 112. It may be understood that the vehicle controller 112 described herein may be a single controller having all of the described functionality, or it may include multiple controllers wherein the described functionality is distributed among the multiple controllers.

Various operations, steps or algorithms as described in connection with the vehicle controller 112 can be embodied directly in hardware, in a computer program product such as a software module executed by the processor 150, or in a combination of the two. The computer program product can reside in RAM memory, flash memory, ROM memory, EPROM memory, EEPROM memory, registers, hard disk, a removable disk, or any other form of computer-readable medium 152 known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” 150 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The communication unit 154 may support or provide communications between the controller and external systems or devices, and/or support or provide communication interface with respect to internal components of the work vehicle 102. The communications unit may include wireless communication system components (e.g., via cellular modem, WiFi, Bluetooth or the like) and/or may include one or more wired communications terminals such as universal serial bus ports.

The data storage 156 in an embodiment may for example be configured to receive and store real-time and/or historical data sets regarding work vehicle characteristics, kinetics, position, and the like, and/or generated plans including assigned turn types, work area/field boundary parameters, and the like in selectively retrievable form, for example as inputs for developing models as may be used for generating plans based on future input data sets. Data storage as discussed herein may, unless otherwise stated, generally encompass hardware such as volatile or non-volatile storage devices, drives, memory, or other storage media, as well as one or more databases residing thereon.

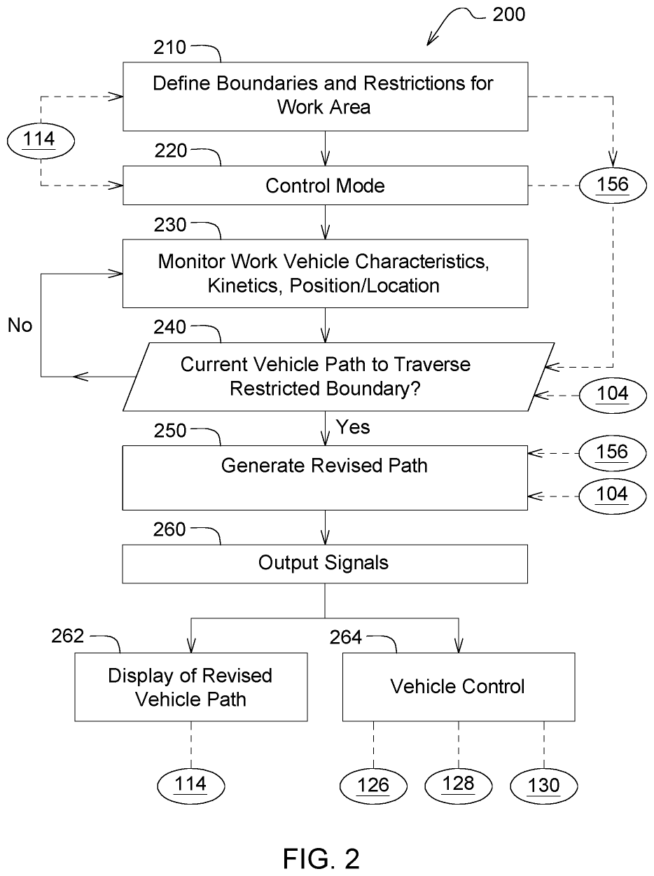

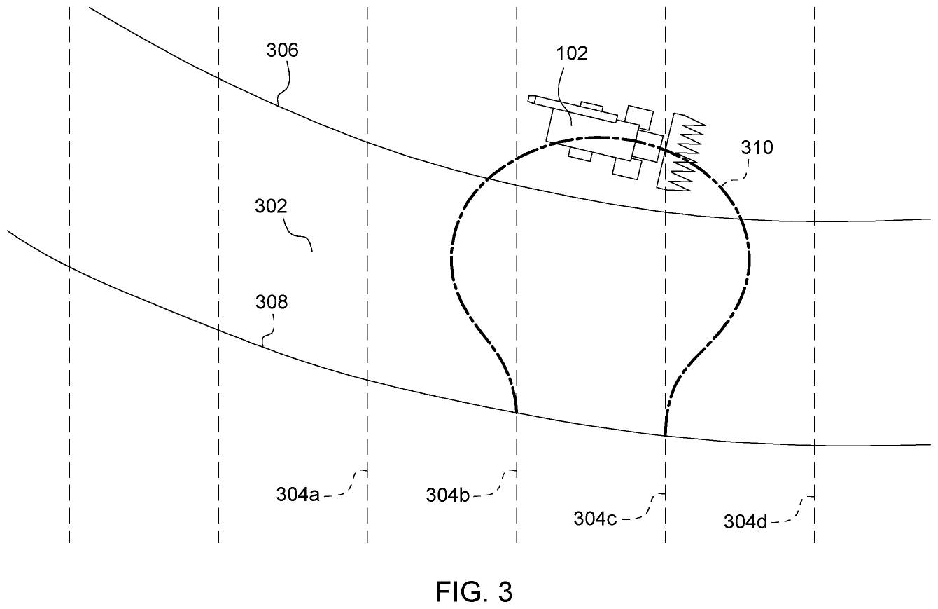

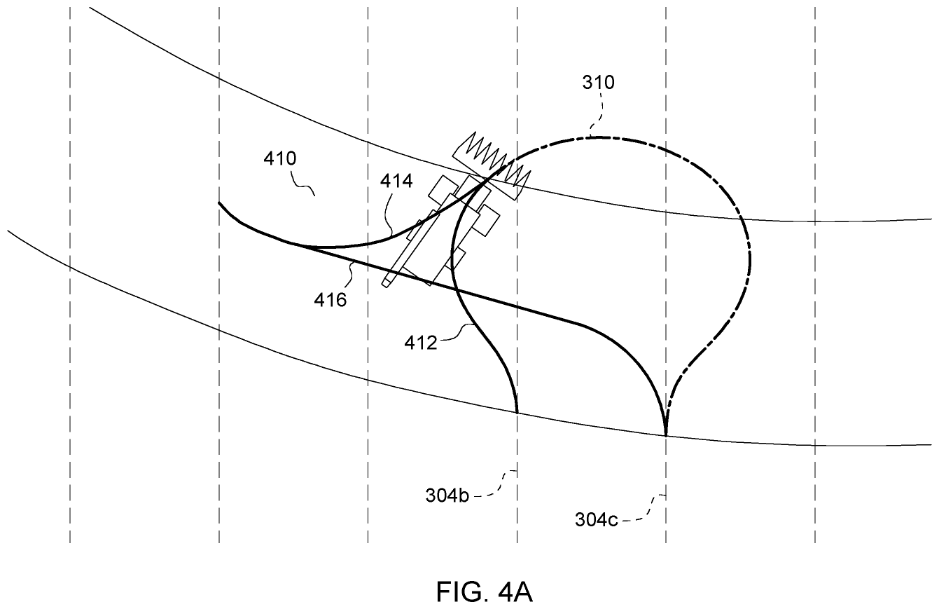

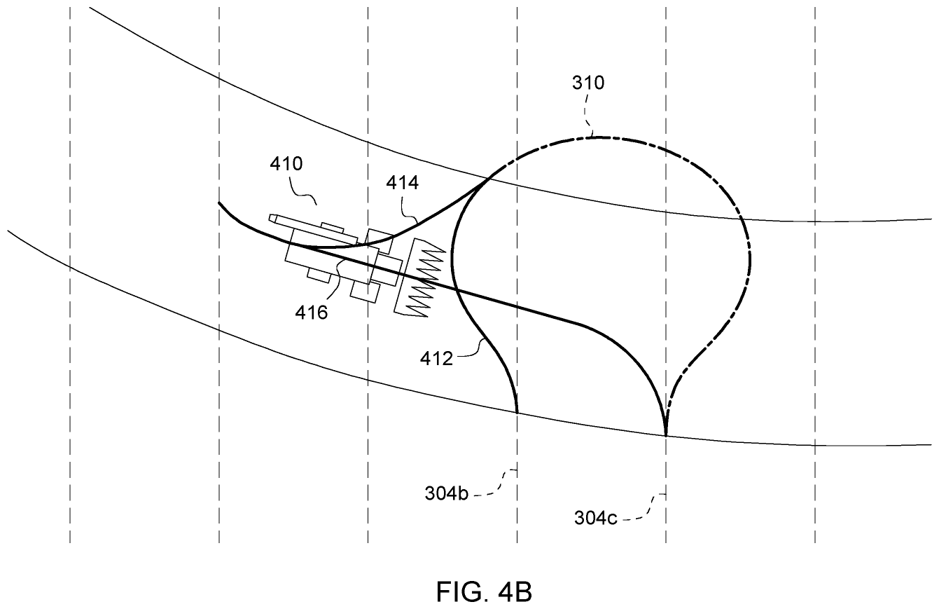

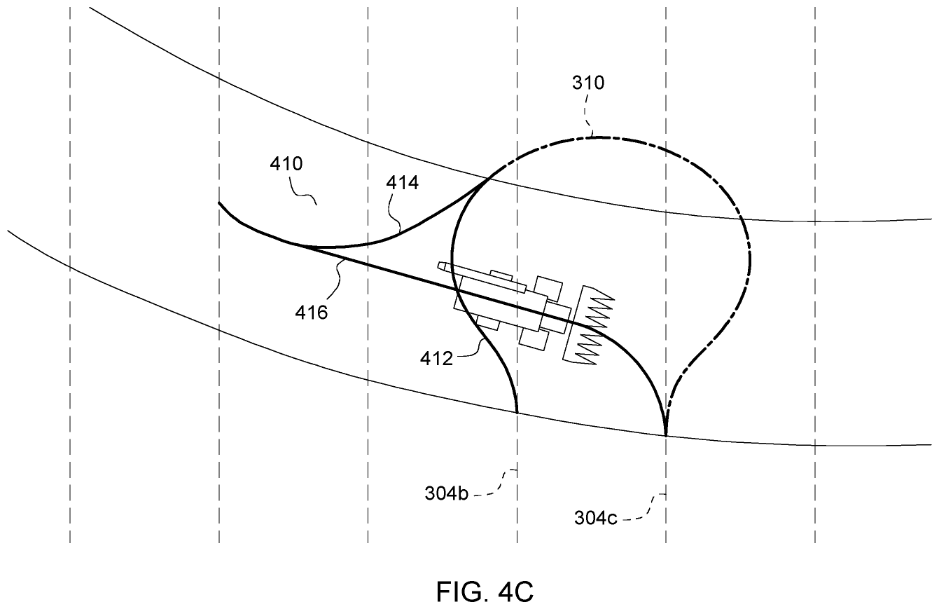

Referring to FIG. 2, with further reference to FIGS. 3-4C for illustrative purposes, a method 200 of planning and implementing work vehicle paths with respect to a defined work area may next be described.

A work area may be defined as an initial step 210 with respect to the vehicle controller 112, for example but not necessarily using direct user input via user interface 114. In an embodiment, the work area may be predetermined and uploaded or otherwise obtained from a remote data source prior to or otherwise in association with a work operation. In an embodiment, an initial map associated with the work area may be provided and capable of dynamic alteration by an operator or other authorized user to define boundaries, contours, or other relevant parameters of the work area, wherein such alterations may at least be locally and temporarily saved by the vehicle controller 112 for application in association with methods as further described herein.

The user interface 114 may be configured to receive the user input 202 for defining a work area such as for example shown in FIG. 3 as including a non-passable exterior field boundary 306 and a passable interior field boundary 308. Passable boundaries 308 may for example include headland boundaries defined based on input offset values with respect to one or more contours of a previously defined exterior field boundary 306, wherein a headland region 302 is defined in between. For example, a constant offset may be applied across the entirety of an exterior field boundary 306, or individual offsets (e.g., top and bottom offsets) may be applied to respective contours of the exterior field boundary 306. A headland region 302 may include one or more headland passes as measured actual driven passes or an applied value based on known work vehicle parameters of an outer region associated with the work area. In various embodiments, including embodiments as further describe herein for illustrative purposes, headland boundaries may be generally defined as passable boundaries 308 for the work vehicle 102, whereas the exterior field boundaries 306 may be generally defined as impassable. Additional passable interior boundaries, as well as impassable interior boundaries and corresponding passable headland boundaries (not shown) may further be defined as part of a work area. In various embodiments, the passable interior boundaries 308 and the headland boundaries (for both of the impassable interior boundaries and the impassable exterior boundaries) may be used to prompt users and/or the system automation to make determinations as disclosed herein and further to selectively complete previously defined sequences and/or turns.

The user interface 114 or other component associated with the vehicle controller 112 may further optionally be configured to receive user input for selecting a control mode (step 220). Selected control modes may simply include a manual or automatic mode, or may include a number of hybrid modes wherein turn types are initially manually selected but may be automatically adjusted, initially automatically selected but manually adjustable, etc. The control mode may in various embodiments be at least partially automatically selected in accordance with other work states, work vehicle conditions, work vehicle characteristics, defined work areas, or the like, rather than relying entirely on user input.

The method 200 may continue in step 230 by monitoring, determining, and/or predicting a current path of the work vehicle 102, for example continuously, to determine and/or predict (in step 240) whether the current path of the work vehicle 102 will traverse an existing non-passable boundary 306.

As used herein, the term “traverse” may refer to the crossing of a defined boundary, such that for example the work vehicle 102 advances from an appropriate region of the work area into a restricted region on an opposing side of the defined boundary, or the crossing of a region ending with a defined boundary, such that for example the work vehicle 102 has traversed a headland region and thereby advanced across a non-passable boundary at a distal end of the headland region with respect to an appropriate portion of the work area.

In carrying out the monitoring, determining, and/or predicting step 230, a system 100 as disclosed herein may obtain, for example by retrieving from data storage 156 or receiving from a sensor system 104, values for work vehicle characteristics, work vehicle kinetics, work vehicle position/location/orientation, and the like. Work vehicle characteristics may include structural characteristics defining capabilities of the work vehicle 102 such as for example a minimum turn radius, a wheel angle rate, and the like. Such characteristics may be permanent in nature based on the structure of the work vehicle 102, or may be dependent at least in part on a configuration of the work vehicle 102 which is not permanent but based on a type of implement mounted thereupon, a type of work being performed, etc. Work vehicle kinetics may for example include an advance speed of the work vehicle 102 as well as potentially any kinetics associated with implements associated with the work vehicle 102. The system 100 may further monitor or otherwise consider work conditions such as for example a terrain or other features being worked by the work vehicle 102, weather conditions, or the like.

In carrying out step 240, the system 100 may consider a current path 310 such as for example a programmed path for the work vehicle and proactively determine that the programmed path will cause the work vehicle 102 to traverse a non-passable boundary 306. In addition, or alternatively, the system 100 may monitor a current path and/or trajectory of the work vehicle 102 and determine that the work vehicle 102 is unable (for example, based on current work conditions and/or configuration/characteristics of the work vehicle 102) to effectively complete a programmed or predicted turn without traversing the non-passable boundary 306. In an exemplary but non-limiting embodiment, the system 100 may be automatically triggered to perform such a step upon crossing a passable boundary 308 (e.g., entering into a headland region 302 proximate to a non-passable boundary 306), rather than continuously collecting and analyzing the aforementioned work vehicle characteristics, work vehicle kinetics, work vehicle position/location/orientation, and the like.

If a current vehicle path 310 is not determined or predicted to cause traverse of a non-passable boundary 306 by the work vehicle 102 (e.g., “no” in response to the query in step 240), the method 200 as illustrated merely returns to step 230 and continues monitoring the aforementioned work vehicle characteristics, work vehicle kinetics, work vehicle position/location/orientation, and the like.

If the current vehicle path 310 is however determined or predicted to cause traverse of a non-passable boundary 306 by the work vehicle 102 (e.g., “yes” in response to the query in step 240), as for example illustrated in FIG. 3, the method 200 may continue by generating a revised vehicle path (step 250). Such a condition may for example arise where a current work vehicle path 310 is established based on an understanding that the exterior boundary is passable, but it is determined or otherwise updated during a work operation to define the exterior boundary as instead being non-passable.

Rather than allowing the work vehicle 100 to continue along an initial path 310 and across a non-passable boundary 306 as shown in FIG. 3, a revised vehicle path 410 may for example be generated which enables the work vehicle 102 to transition from a first parallel track 304b of the initial path 310 (as illustrated approaching the boundary 306 in question) to a second parallel track 304c of the initial path 310 (as illustrated leading away from the boundary 306 in question), without traversing the boundary 306.

One example of a revised vehicle path 410 and implementation thereof may be as shown in FIGS. 4A to 4C, wherein a first portion 412 of the revised vehicle path 410 roughly coincides with a corresponding portion of the initial path 310 as it approaches but does not traverse the non-passable boundary 306. A second portion 414 of the revised vehicle path 410 leads away from the non-passable boundary 306 at an angle that can be traced in reverse by the work vehicle 102. A third portion 416 of the revised vehicle path 410 guides the work vehicle 102 forward to intersect with the second parallel track 304c of the initial path 310 as it crosses the passable boundary 308.

It should be noted that the revised path 410 as shown is merely illustrative and not limiting on the scope of potential paths that may be generated and implemented in accordance with the present disclosure. For example, the revised path 410 does not necessarily intersect with the initial vehicle path 310 at a passable boundary 308, as indeed a passable boundary 308 may not even be present. As another example, the revised path 410 may take any number of forms depending on the work vehicle characteristics, work conditions, and the like, such that the work vehicle 102 is capable of executing the revised vehicle path 410, and/or the revised vehicle path 410 satisfies any predetermined requirements for a path associated with the work area as further described below, etc.

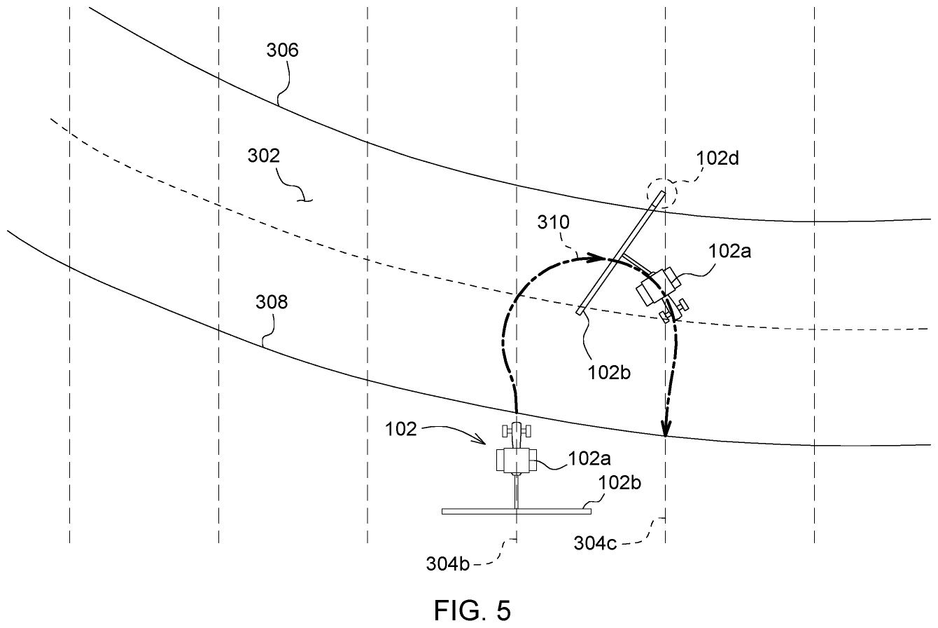

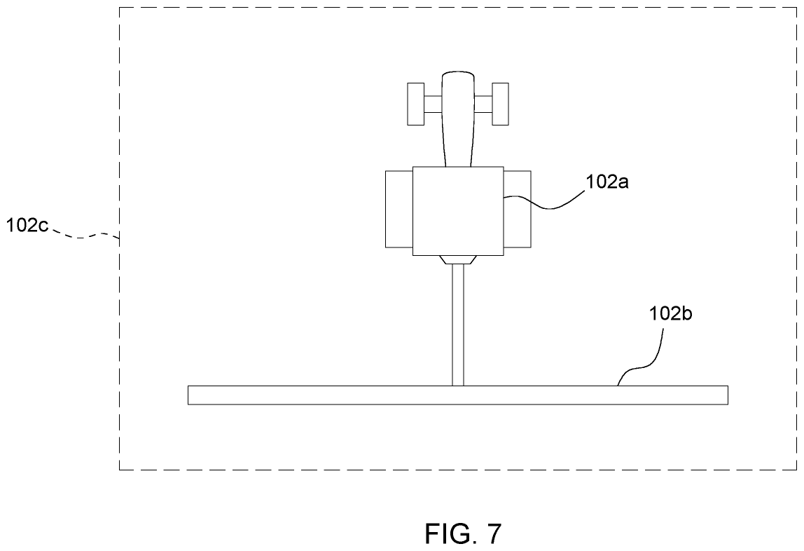

One further example is shown in FIGS. 5-7 in which the vehicle 102 is shown as including a tractor 102a and a towed implement 102b. FIG. 7 schematically shows a virtual boundary 102c of the vehicle 102 which may be used to conduct a boundary hit test to determine whether the vehicle 102 will cross the non-passable boundary 306.

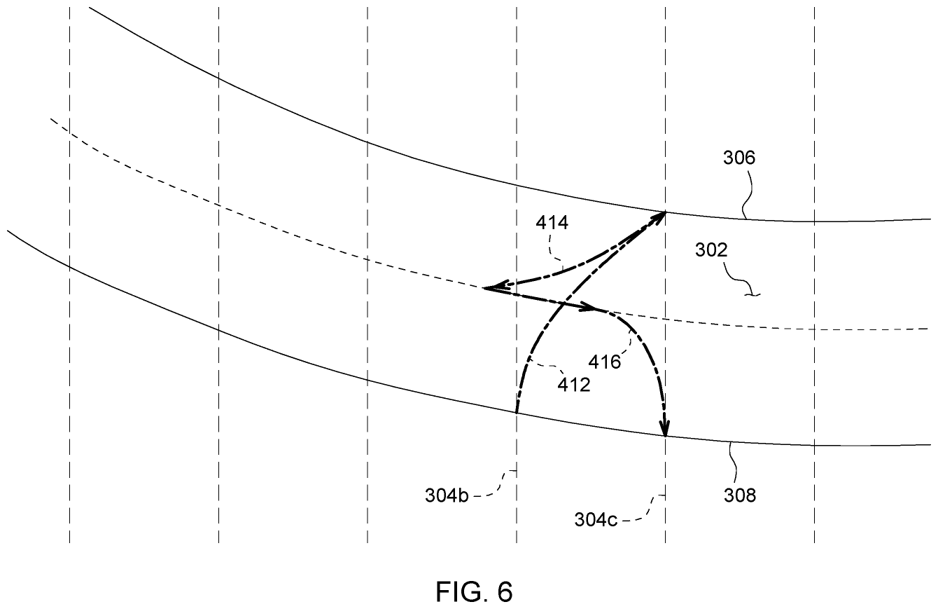

In FIGS. 5 and 6 the headland region 302, parallel tracks 304b and 304c, non-passable boundary 306, passable boundary 308 and initial vehicle path 310 all use the same numbering system as discussed above for the example of FIGS. 3 and 4A-4C and have the same meanings.

As can be seen in FIG. 5 if the vehicle 102 follows the initial vehicle path 310 to make a U-turn from the track 304b to the track 304c, a portion of the towed implement 102b of vehicle 102 in an area generally indicated as 102d will cross the non-passable boundary.

FIG. 6 schematically shows an example of a revised vehicle path 410 wherein a first portion 412 of the revised vehicle path 410 approaches but does not traverse the non-passable boundary 306. A second portion 414 of the revised vehicle path 410 leads away from the non-passable boundary 306 at an angle that can be traced in reverse by the work vehicle 102. A third portion 416 of the revised vehicle path 410 guides the work vehicle 102 forward to intersect with the second parallel track 304c of the initial path 310 as it crosses the passable boundary 308.

In an embodiment, when a revised vehicle path 410 is required for a given approach to the non-passable boundary 306, the system 100 may be able to select from a plurality of predetermined paths (e.g., a sequence of turns and forward/reverse advances along defined tracks) based on the determined work vehicle characteristics, work vehicle kinetics, work conditions, and the like. In various embodiments, such a library of predetermined paths may alternatively be unavailable for review and selection, wherein the system 100 is configured to dynamically generate an optimal revised vehicle path 410 to suit the parameters of the current situation. For example, it may be understood that any number of turn and/or forward/reverse advance combinations may be applicable by the system for a given revised vehicle path 410, optionally dependent on any one or more of vehicle characteristics, work state, work area conditions, work area contours, etc.

In an embodiment, a revised vehicle path 410 may be manually selectable by an operator or other authorized user from a library of vehicle paths. The system may in an embodiment only present a subset of all vehicle paths as being available for user selection based on any one or more of vehicle characteristics, work state, work area conditions, work area contours, etc. Such an option may for example be available based on the selected control mode in step 220, wherein the user or other authorized user is allowed to determine whether the revised vehicle path 410 is manually selected or automatically selected/generated even prior to the determination that a revised vehicle path 410 is actually necessary.

With a revised vehicle path 410 having been manually or automatically selected in step 214, the method 200 may continue by automatically generating output signals (step 260) to the user interface 114 or other device with an appropriate display unit for displaying the generated revised vehicle path for operator execution (step 262) or automatically performing the generated revised vehicle path (step 264).

In various embodiments, selection of a revised vehicle path 410 may for example be made based upon one or more specified quality metrics using executed optimization routines and corresponding models which may be predetermined or developed over time, extracted from data storage based on dynamic input data sets, and the like. Quality metrics may be specified for a given work cycle based on a control mode, predetermined for a type of work vehicle or work operation, and the like. Exemplary quality metrics may include optimization of a work vehicle footprint, such as reducing an amount of work area traversed or an amount of a particular portion of the work area traversed for at least a current work vehicle path, and/or optimization of work coverage by the work vehicle or a plurality of work vehicles including the work vehicle, such as maximizing an amount of at least a portion of the work area to be traversed with a minimal number of work vehicle passes/turns. Optimization routines may in various embodiments further account for various current work vehicle operating characteristics and conditions, cost parameters, time parameters, operator parameters, and the like.

In an embodiment, the revised vehicle path 410 may be generated further in view of a monitored work coverage by the work vehicle 102, alone or optionally in combination with one or more additional work vehicles. A coverage monitor may be implemented, as part of the vehicle controller 112 or as a discrete module, to determine where the work vehicle 102 and/or any implement, such as a front implement on a combine or a towed planter by a tractor, has covered as the implement travels through the work area. Vehicle controller 112 may be configured to collect location data on one or more points in the work area, such as for collecting and storing GPS coordinates from a GPS receiver with differential correction as the work vehicle 102 traverses an outer region of the work area along the exterior boundary 306 and/or any other area of the work area.

In various embodiments, a particular control mode may be available for optimization of, e.g., work vehicle footprint, work coverage, and the like wherein a revised vehicle path 410 is dynamically generated for each respective pass based on a best fit analysis with respect to the contours of the work area, further in view of the operating conditions and parameters at a given time. In other words, the shape, turn radius, points of traverse, and other characteristics of a generated path may vary for a given work area, or even for given passes/track paths within the work area, based on current conditions and a dynamically determined best fit for the work vehicle for optimizing the work vehicle footprint, work coverage, and the like. In an embodiment, the best fit implementation is not limited to any one predetermined turn type or sequence but may involve a best fit analysis with respect to any of one or more available turn types to determine a best fit for a given pass and with respect to contours of the work area, even if a predetermined type of turn may otherwise be selected or programmed as a default. The best fit analysis may for example be performed for each available turn type with respect to an optimization routine to reduce an amount of the work area traversed while remaining within external contours of the work area. Such a routine may be predetermined or may be developed over time based on correlation of stored input data sets for each of the various turns with respect to different output parameters such as an area traversed by the work vehicle for example on a per-pass basis, work area coverage for a plurality of passes defining a work plan (e.g., a plurality of path plans, alone or in combination with determined turn plans), and the like.

In an embodiment, the system 100 may be configured to monitor various vehicle characteristics, kinetics, and/or work conditions for determining whether completion of a revised vehicle path 410 remains viable. If the assigned sequence of turns and/or forward/reverse advances cannot be completed based on the monitored characteristics, kinetics, and/or conditions, the vehicle controller 112 may be configured to generate or select an alternative revised vehicle path 410 that can be completed, and automatically direct execution thereof. When determining whether a revised vehicle path 410 can be completed, the vehicle controller 112 may for example account for whether or not the revised vehicle path 410 would violate one or more established rules or thresholds, or otherwise to satisfy any one or more predetermined conditions (e.g., optimization of footprint and/or work coverage for a given pass or work cycle).

In an embodiment, generation and implementation of a revised vehicle path 410 by a first work vehicle 102 as disclosed herein may further be accompanied by communication of the revised vehicle path 410 or various aspects thereof to one or more other work vehicles associated with the work area or a central communications hub with respect thereto, for example to facilitate routing of any additional work vehicles to avoid duplicative traversal of the work area, to facilitate generation of subsequent revised vehicle paths for work vehicles travelling along parallel or otherwise proximate current vehicle paths, to inform the work vehicles of determined changes in the boundary or work conditions, and the like. In certain embodiments, a corresponding nature of current vehicle paths for a plurality of work vehicles working in the same work area may further influence the generation of a revised vehicle path for any one or more of the work vehicles, as for example the revised vehicle path may be generated to avoid overlap or otherwise interference with vehicle paths associated with any of the other work vehicles in the work area.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

One of skill in the art may appreciate that when an element herein is referred to as being “coupled” to another element, it can be directly connected to the other element or intervening elements may be present.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method of guidance and/or automation for a self-propelled work vehicle operating within a defined work area, the method comprising:
determining at least one boundary with respect to the defined work area as being restricted for traverse by the work vehicle;
determining a current vehicle path will traverse a portion of the at least one boundary;
automatically generating a revised vehicle path based on the portion of the at least one boundary and further at least in part on one or more vehicle motion characteristics; and
producing one or more output signals corresponding to the revised vehicle path.

2. The method of claim 1, wherein the one or more vehicle motion characteristics comprise an available minimum turn radius and/or a wheel angle rate determined with respect to the work vehicle.

3. The method of claim 1, comprising:
determining a further at least one boundary internally disposed with respect to the restricted at least one boundary,
wherein the further at least one boundary is unrestricted for traverse by the work vehicle, and
wherein the step of determining the current vehicle path will traverse the portion of the restricted at least one boundary is responsive to determining a traverse by the work vehicle of a portion of the further at least one boundary.

4. The method of claim 1, comprising predicting a traverse of the portion of the at least one boundary based at least in part on a detected position and detected motion of the work vehicle, further accounting for at least one of the one or more vehicle motion characteristics.

5. The method of claim 1, further comprising a controlled intervention in at least an advance of the work vehicle with respect to the portion of the at least one boundary, responsive to the produced one or more output signals.

6. The method of claim 5, comprising automating implementation of the revised vehicle path via automatically controlled operating parameters for the work vehicle.

7. The method of claim 1, wherein the one or more output signals are provided to an onboard display unit associated with the work vehicle to generate a display highlighting one or more aspects of the revised vehicle path.

8. The method of claim 1, comprising analyzing one or more of a plurality of predetermined vehicle turn types with respect to the portion of the at least one boundary, based at least in part on a detected position and detected motion of the work vehicle, further accounting for at least one of the one or more vehicle motion characteristics, and selectively generating the revised vehicle path as corresponding to at least one of the one or more predetermined vehicle turn types.

9. The method of claim 8, comprising, upon determining that none of the plurality of predetermined vehicle turn types are available for generating the revised vehicle path, based at least in part on the detected position and the detected motion of the work vehicle, further accounting for the at least one of the one or more vehicle motion characteristics, generating a new turn type with respect to the portion of the at least one boundary.

10. A system for guidance and/or automation of a self-propelled work vehicle operating within a defined work area, the system comprising:
data storage having stored thereon one or more vehicle motion characteristics;
one or more sensors configured to detect a position and/or motion of the work vehicle; and
at least one computing device functionally linked to the data storage and configured to direct the performance of operations comprising:
determining at least one boundary with respect to the defined work area as being restricted for traverse by the work vehicle;
determining a current vehicle path will traverse a portion of the at least one boundary;
automatically generating a revised vehicle path based on the portion of the at least one boundary and further at least in part on one or more vehicle motion characteristics; and
producing one or more output signals corresponding to the revised vehicle path.

11. The system of claim 10, wherein the stored one or more vehicle motion characteristics comprise an available minimum turn radius and/or a wheel angle rate with respect to the work vehicle.

12. The system of claim 10, wherein:
the at least one computing device is configured to determine a further at least one boundary internally disposed with respect to the restricted at least one boundary,
the further at least one boundary is unrestricted for traverse by the work vehicle, and
the operation of determining the current vehicle path will traverse the portion of the restricted at least one boundary is responsive to determining a traverse by the work vehicle of a portion of the further at least one boundary.

13. The system of claim 10, wherein the at least one computing device is configured to predict a traverse of the portion of the at least one boundary based at least in part on a detected position and detected motion of the work vehicle, further accounting for at least one of the one or more vehicle motion characteristics.

14. The system of claim 10, wherein the at least one computing device is configured to direct a controlled intervention in at least an advance of the work vehicle with respect to the portion of the at least one boundary, responsive to the produced one or more output signals.

15. The system of claim 14, wherein the at least one computing device is configured to direct automating implementation of the revised vehicle path via automatically controlled operating parameters for the work vehicle.

16. The system of claim 10, wherein the one or more output signals are provided to an onboard display unit associated with the work vehicle to generate a display highlighting one or more aspects of the revised vehicle path.

17. The system of claim 10, wherein the at least one computing device is configured to:
analyze one or more of a plurality of predetermined vehicle turn types with respect to the portion of the at least one boundary, wherein the predetermined vehicle turn types are stored in the data storage, based at least in part on a detected position and detected motion of the work vehicle, further accounting for at least one of the one or more vehicle motion characteristics; and
selectively generate the revised vehicle path as corresponding to at least one of the one or more predetermined vehicle turn types.

18. The system of claim 17, wherein the at least one computing device is configured to, upon determining that none of the plurality of predetermined vehicle turn types are available for generating the revised vehicle path, based at least in part on the detected position and the detected motion of the work vehicle, further accounting for the at least one of the one or more vehicle motion characteristics, generate a new turn type with respect to the portion of the at least one boundary.

19. A self-propelled work vehicle comprising the system of claim 10.

20. The work vehicle of claim 19, wherein the at least one computing device comprises a vehicle controller.
